(19) United States
(12) Patent Application Publication
(10) Pub. No.: US 2011/0115791 A1
(43) Pub. Date: May 19, 2011

(54) METHOD, APPARATUS, SIGNALS, AND MEDIA FOR PRODUCING A COMPUTER REPRESENTATION OF A THREE-DIMENSIONAL SURFACE OF AN APPLIANCE FOR A LIVING BODY

(75) Inventor: Robert Malcolm Sabiston, Vancouver (CA)

(73) Assignee: VORUM RESEARCH CORPORATION, Vancouver, BC (CA)

(21) Appl. No.: 13/054,722

(22) PCT Filed: Jul. 18, 2008
(86) PCT No.: PCT/CA2008/001362

§ 371 Date: Jan. 18, 2011

(51) Int. Cl. G06T 15/00

(52) U.S. Cl. 345/419

(57) ABSTRACT

A method and apparatus for producing a computer representation of a three-dimensional surface of an appliance for a living body is disclosed. The method involves identifying a plurality of spaced apart planes intersecting the three-dimensional surface, and for each plane in the plurality of spaced apart planes identifying a plurality of basis points on the plane. The basis points lie generally along a curve on the plane. The method also involves determining surface coordinate locations of a plurality of points on the plane that lie on the three-dimensional surface, each surface coordinate location being defined as an offset from the basis point, and storing the surface coordinate locations in a computer memory.

### BACKGROUND OF THE INVENTION

1. Field of Invention

This invention relates generally to three-dimensional shape representations and more particularly to producing a computer representation of a three-dimensional surface of an appliance for a living body

2. Description of Related Art

Prostheses, orthoses, and other support appliances are commonly produced from three-dimensional representations of a body part of a human or an animal. The three-dimensional representation may then be manipulated on a computer using a three-dimensional shape editing program to produce a modified representation of the body part. The modified representation may be used to generate instructions for controlling a carving machine that is configured to directly produce an appliance, or to produce a mold for making appliance, for example. An orthosis is an appliance that is applied externally to a body part to correct deformity, improve function, or relieve symptoms of a disease by supporting oil assisting the musculo-neuro-skeletal system. A prosthesis is an appliance that replaces a missing body part. Other appliances such as supporting seats or standing shells for supporting the body of a person having limited mobility may also be produced from modified representations of body parts.

The three-dimensional representation of the body part may be produced using a non-contact optical scanner that images the body part with a high level of accuracy. The scanner may include a laser for illuminating the body part with structured light and a video camera for capturing images of the illuminated body part. The captured images may then be processed to extract coordinates of the surface of the body part, which may be used as input coordinates to a computer for producing three-dimensional representations.

It is generally convenient to represent three-dimensional shapes of surfaces using a plurality of two-dimensional slices or planes that permit three-dimensional surface coordinates to be represented and manipulated in two-dimensions. Each surface coordinate location in the two-dimensional plane may be represented using an angle and an offset from a plane origin point. Such representations are usually satisfactory for representing generally cylindrical shapes but may not be satisfactory in representing more complex shapes.

### SUMMARY OF THE INVENTION

In accordance with one aspect of the invention there is provided a method for producing a computer representation of a three-dimensional surface of an appliance for a living body. The method involves identifying a plurality of spaced apart planes intersecting the three-dimensional surface and for each plane in the plurality of spaced apart planes identifying a plurality of basis points on the plane. The basis points lie generally along a curve on the plane. The method also involves determining surface coordinate locations of a plurality of points on the plane that lie on the three-dimensional surface, each surface coordinate location being defined as an offset from the basis point, and storing the surface coordinate locations in a computer memory.

The method may involve receiving an input plurality of coordinates defining a preliminary representation of the three-dimensional surface.

The method may involve transforming the surface coordinate locations into a set of instructions operable to control a computer aided manufacturing machine to produce the appliance.

The method may involve applying a shape transformation to the surface coordinate locations to produce modified surface coordinate locations and storing the surface coordinate locations in the computer memory may involve storing the modified surface coordinate locations in the computer memory.

Identifying the plurality of spaced apart planes may involve identifying a plurality of plane coordinate frames respectively identifying locations and orientations of the plurality spaced apart planes in a three-dimensional coordinate system.

Identifying the plurality of plane coordinate frames may involve identifying origin coordinate locations of a plurality of spaced apart points along a reference curve, the reference curve having a shape that generally corresponds to a shape of the three-dimensional surface in a first general direction along the surface, and for each respective origin coordinate location, generating data defining a plane coordinate frame having an origin located at the origin coordinate location and being oriented to cause a corresponding plane defined by the plane coordinate frame to be orthogonally oriented with respect to a portion of the reference curve passing through the origin coordinate location.

The method may involve displaying a representation of the three-dimensional surface, and receiving operator input identifying control point locations defining the reference curve.

Generating the data defining the plane coordinate frame may involve generating data defining a Cartesian coordinate frame having a first axis oriented in a direction along the reference curve at the origin coordinate location and second and third axes defining the orientation of the plane.

Identifying the origin coordinate locations may involve identifying regularly spaced apart origin coordinate locations along the reference curve.

Identifying the plurality of plane coordinate frames may involve, for each of the plurality of plane coordinate frames, generating a modeling matrix having elements defining orthogonal unit vectors, the orthogonal unit vectors identifying an orientation of the plane coordinate frame, and elements defining an origin coordinate location of the plane coordinate frame.

Determining the surface coordinate locations may involve determining two-dimensional surface coordinate locations with respect to the plane coordinate frame, and transforming the two-dimensional surface coordinates into three-dimensional coordinates in the three-dimensional coordinate system using the modeling matrix.

The method may involve defining at least one basis curve located on a basis curve plane intersecting the three-dimensional surface, and subdividing the at least one basis curve to identify a plurality of points along the basis curve, and identifying the plurality of basis points on each of the planes may involve projecting respective points in the plurality of points along the basis curve onto each of the planes.

Projecting the respective points may involve at least one of interpolating between points located on at least two basis curves located on respective basis curve planes, and extrapolating from at least one point located on the at least one basis curve.

Defining the at least one basis curve located on the basis curve plane may involve defining at least one basis curve located on one of the spaced apart plurality of planes.

Defining the basis curve may involve defining control points of a B-spline curve located in the plane.

Each the basis curve plane may be defined by a basis curve plane coordinate frame identifying a location and orientation of the plane in a three-dimensional coordinate system and defining the control points of the B-spline curve may involve defining control point coordinate locations in the basis curve plane coordinate frame.

The method may involve displaying a representation of the basis curve plane, and defining the control point coordinate location may involve receiving operator input identifying the control point coordinate locations on the basis curve plane.

Displaying the representation of the basis curve plane may involve displaying an orthographic view of the plane.

Displaying the orthographic view may further involve displaying a polyline representing a shape of the three-dimensional surface in the plane to facilitate selection of the control point locations defining the B-spline curve.

The method may involve determining two-dimensional coordinate locations on the plane of a polyline linking points of intersection between the three-dimensional surface and the plane and determining the offset from each the basis point may involve determining a distance between the basis point and a point of intersection between the polyline and a ray extending from the basis point in a direction normal to the curve.

Determining the two-dimensional coordinate locations on the plane of the polyline may involve determining three-dimensional coordinates of the points of intersection and transforming the points of intersection into two-dimensional coordinates on the plane.

In accordance with another aspect of the invention there is provided an apparatus for producing a computer representation of a three-dimensional surface of an appliance for a living body. The apparatus includes provisions for identifying a plurality of spaced apart planes intersecting the three-dimensional surface, and provisions for identifying a plurality of basis points for each plane in the plurality of spaced apart planes, the basis points lying generally along a curve on the plane. The apparatus also includes provisions for determining surface coordinate locations of a plurality of points on each the plane that lie on the three-dimensional surface, each surface coordinate location being defined as an offset from the basis point, and provisions for storing the surface coordinate locations in a computer memory.

The apparatus may include provisions for receiving an input plurality of coordinates defining a preliminary representation of the three-dimensional surface.

The apparatus may include provisions for transforming the surface coordinate locations into a set of instructions operable to control a computer aided manufacturing machine to produce the appliance.

The apparatus may include provisions for applying a shape transformation to the surface coordinate locations to produce modified surface coordinate locations and the provisions for storing the surface coordinate locations in the computer memory may include provisions for storing the modified surface coordinate locations in the computer memory.

The provisions for identifying the plurality of spaced apart planes may include provisions for identifying a plurality of plane coordinate frames respectively identifying locations and orientations of the plurality spaced apart planes in a three-dimensional coordinate system.

The provisions for identifying the plurality of plane coordinate frames may include provisions for identifying origin coordinate locations of a plurality of spaced apart points along a reference curve, the reference curve having a shape that generally corresponds to a shape of the three-dimensional surface in a first general direction along the surface, and provisions for generating data defining respective plane coordinate frames each having an origin located at respective origin coordinate locations and being oriented to cause a corresponding plane defined by the plane coordinate frame to be orthogonally oriented with respect to a portion of the reference curve passing through the origin coordinate location.

The apparatus may include provisions for displaying a representation of the three-dimensional surface, and provisions for receiving operator input identifying control point locations defining the reference curve.

The provisions for generating the data defining the plane coordinate frame may include provisions for generating data defining a Cartesian coordinate frame having a first axis oriented in a direction along the reference curve at the origin coordinate location and second and third axes defining the orientation of the plane.

The provisions for identifying the origin coordinate locations may include provisions for identifying regularly spaced apart origin coordinate locations along the reference curve.

The provisions for identifying the plurality of plane coordinate frames may include provisions for generating a modeling matrix for each of the plurality of plane coordinate frames, each the modeling matrix having elements defining orthogonal unit vectors, the orthogonal unit vectors identifying an orientation of the plane coordinate frame, and elements defining an origin coordinate location of the plane coordinate frame.

The provisions for determining the surface coordinate locations may include provisions for determining two-dimensional surface coordinate locations with respect to the plane coordinate frame, and provisions for transforming the two-dimensional surface coordinates into three-dimensional coordinates in the three-dimensional coordinate system using the modeling matrix.

The apparatus may include provisions for defining at least one basis curve located on a basis curve plane intersecting the three-dimensional surface, provisions for subdividing the at least one basis curve to identify a plurality of points along the basis curve, and the provisions for identifying the plurality of basis points on each of the planes may include provisions for projecting respective points in the plurality of points along the basis curve onto each of the planes.

The provisions for projecting the respective points may include at least one of provisions for interpolating between points located on at least two basis curves located on respective basis curve planes, and provisions for extrapolating from at least one point located on the at least one basis curve.

The provisions for defining the at least one basis curve located on the basis curve plane may include provisions for defining at least one basis curve located on one of the spaced apart plurality of planes.

The provisions for defining the basis curve may include provisions for defining control points of a B-spline curve located in the plane.

Each the basis curve plane may be defined by a basis curve plane coordinate frame identifying a location and orientation of the plane in a three-dimensional coordinate system and the provisions for defining the control points of the B-spline curve may include provisions for defining control point coordinate locations in the basis curve plane coordinate frame.

The apparatus may include provisions for displaying a representation of the basis curve plane, and the provisions for defining the control point coordinate location may include provisions for receiving operator input identifying the control point coordinate locations on the basis curve plane.

The provisions for displaying the representation of the basis curve plane may include provisions for displaying an orthographic view of the plane.

The provisions for displaying the orthographic view may further include provisions for displaying a polyline representing a shape of the three-dimensional surface in the plane to facilitate selection of the control point locations defining the B-spline curve.

The apparatus may include provisions for determining two-dimensional coordinate locations on the plane of a polyline linking points of intersection between the three-dimensional surface and the plane and the provisions for determining the offset from each the basis point may include provisions for determining a distance between the basis point and a point of intersection between the polyline and a ray extending from the basis point in a direction normal to the curve.

The provisions for determining the two-dimensional coordinate locations on the plane of the polyline may include provisions for determining three-dimensional coordinates of the points of intersection and provisions for transforming the points of intersection into two-dimensional coordinates on the plane.

In accordance with another aspect of the invention there is provided an apparatus for producing a computer representation of a three-dimensional surface of an appliance for a living body. The apparatus includes a processor circuit operably configured to identify a plurality of spaced apart planes intersecting the three-dimensional surface, and for each plane in the plurality of spaced apart planes, to identify a plurality of basis points on the plane, the basis points lying generally along a curve on the plane. The processor circuit is also operably configured to determine surface coordinate locations of a plurality of points on the plane that lie on the three-dimensional surface, each surface coordinate location being defined as an offset from the basis point, and to store the surface coordinate locations in a computer memory.

The processor circuit may be operably configured to receive an input plurality of coordinates defining a preliminary representation of the three-dimensional surface.

The processor circuit may be operably configured to transform the surface coordinate locations into a set of instructions operable to control a computer aided manufacturing machine to produce the appliance.

The processor circuit may be operably configured to apply a shape transformation to the surface coordinate locations to produce modified surface coordinate locations and to store the surface coordinate locations in the computer memory by storing the modified surface coordinate locations in the computer memory.

The processor circuit may be operably configured to identify the plurality of spaced apart planes by identifying a plurality of plane coordinate frames respectively identifying locations and orientations of the plurality spaced apart planes in a three-dimensional coordinate system.

The processor circuit may be operably configured to identify the plurality of plane coordinate frames by identifying origin coordinate locations of a plurality of spaced apart points along a reference curve, the reference curve having a shape that generally corresponds to a shape of the three-dimensional surface in a first general direction along the surface, and for each respective origin coordinate location, generating data defining a plane coordinate frame having an origin located at the origin coordinate location and being oriented to cause a corresponding plane defined by the plane coordinate frame to be orthogonally oriented with respect to a portion of the reference curve passing through the origin coordinate location.

The processor circuit may be operably configured to display a representation of the three-dimensional surface, and receive operator input identifying control point locations defining the reference curve.

The processor circuit may be operably configured to generate the data defining the plane coordinate frame by generating data defining a Cartesian coordinate frame having a first axis oriented in a direction along the reference curve at the origin coordinate location and second and third axes defining the orientation of the plane.

The processor circuit may be operably configured to identify the origin coordinate locations by identifying regularly spaced apart origin coordinate locations along the reference curve.

The processor circuit may be operably configured to identify the plurality of plane coordinate frames by generating a modeling matrix for each of the plurality of plane coordinate frames, the modeling matrix having elements defining orthogonal unit vectors, the orthogonal unit vectors identifying an orientation of the plane coordinate frame, and elements defining an origin coordinate location of the plane coordinate frame.

The processor circuit may be operably configured to determine the surface coordinate locations by determining two-dimensional surface coordinate locations with respect to the plane coordinate frame, and transforming the two-dimensional surface coordinates into three-dimensional coordinates in the three-dimensional coordinate system using the modeling matrix.

The processor circuit may be operably configured to define at least one basis curve located on a basis curve plane intersecting the three-dimensional surface, to subdivide the at least one basis curve to identify a plurality of points along the basis curve, and the processor circuit may be operably configured to identify the plurality of basis points on each of the planes by projecting respective points in the plurality of points along the basis curve onto each of the planes.

The processor circuit may be operably configured to project the respective points by at least one of interpolating between points located on at least two basis curves located on respective basis curve planes, and extrapolating from at least one point located on the at least one basis curve.

The processor circuit may be operably configured to define the at least one basis curve located on the basis curve plane by defining at least one basis curve located on one of the spaced apart plurality of planes.

The processor circuit may be operably configured to define the basis curve by defining control points of a B-spline curve located in the plane.

Each basis curve plane may be defined by a basis curve plane coordinate frame identifying a location and orientation of the plane in a three-dimensional coordinate system and the processor circuit may be operably configured to define the control points of the B-spline curve by defining control point coordinate locations in the basis curve plane coordinate frame.

The processor circuit may be operably configured to display a representation of the basis curve plane and to define the control point coordinate location by receiving operator input identifying the control point coordinate locations on the basis curve plane.

The processor circuit may be operably configured to display the representation of the basis curve plane by displaying an orthographic view of the plane.

The processor circuit may be operably configured to display the orthographic view by displaying a polyline representing a shape of the three-dimensional surface in the plane to facilitate selection of the control point locations defining the B-spline curve.

The processor circuit may be operably configured to determine two-dimensional coordinate locations on the plane of a polyline linking points of intersection between the three-dimensional surface and the plane and to determine the offset from each the basis point by determining a distance between the basis point and a point of intersection between the polyline and a ray extending from the basis point in a direction normal to the curve.

The processor circuit may be operably configured to determine the two dimensional coordinate locations on the plane of the polyline by determining three-dimensional coordinates of the points of intersection and by transforming the points of intersection into two-dimensional coordinates on the plane.

In accordance with another aspect of the invention there is provided a computer readable medium encoded with codes for directing a processor circuit to produce a computer representation of a three-dimensional surface of an appliance for a living body. The codes direct the processor circuit to identify a plurality of spaced apart planes intersecting the three-dimensional surface, and for each plane in the plurality of spaced apart planes to identify a plurality of basis points on the plane, the basis points lying generally along a curve on the plane. The codes also direct the processor circuit to determine surface coordinate locations of a plurality of points on the plane that lie on the three-dimensional surface, each surface coordinate location being defined as an offset from the basis point, and to store the surface coordinate locations in a computer memory.

In accordance with another aspect of the invention there is provided a computer readable signal encoded with codes for directing a processor circuit to produce a computer representation of a three-dimensional surface of an appliance for a living body. The codes direct the processor circuit to identify a plurality of spaced apart planes intersecting the three-dimensional surface, and for each plane in the plurality of spaced apart planes to identify a plurality of basis points on the plane, the basis points lying generally along a curve on the plane. The codes also direct the processor circuit to determine surface coordinate locations of a plurality of points on the plane that lie on the three-dimensional surface, each surface coordinate location being defined as an offset from the basis point, and to store the surface coordinate locations in a computer memory.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a perspective view of a system for producing a computer representation of a three-dimensional surface of an appliance for a living body in accordance with a first embodiment of the invention;

FIG. 2 is a block diagram of a processor circuit used in the system shown in FIG. 1;

FIG. 3 is a flowchart of blocks of codes for directing the processor circuit shown in FIG. 2 to execute a process for producing a computer representation;

FIG. 4 is a perspective representation of a three-dimensional surface of an appliance for a living body;

FIG. 5 is a polygon mesh representation of the three-dimensional surface of the appliance shown in FIG. 4;

FIG. 6 is an orthogonal view of a plane shown FIG. 4;

FIG. 7 is a flowchart of blocks of codes for directing the processor circuit shown in FIG. 2 to execute a process for identifying a plurality of planes shown in FIG. 4;

FIG. 8 is a screenshot of an operator interface produced for display by the processor circuit shown in FIG. 2;

FIG. 9 is a perspective view of a portion of a reference curve shown in FIG. 8;

FIG. 10 is a flowchart of blocks of codes for directing the processor circuit shown in FIG. 2 to execute a process for defining basis points;

FIGS. 11-13 are a series of screenshots of views produced for display by the processor circuit shown in FIG. 2; and

FIG. 14 is further orthogonal view of the plane shown FIG. 4;

FIG. 15 is a flowchart of blocks of codes for directing the processor circuit shown in FIG. 2 to execute a process for determining surface coordinate locations.

### DETAILED DESCRIPTION

System Overview

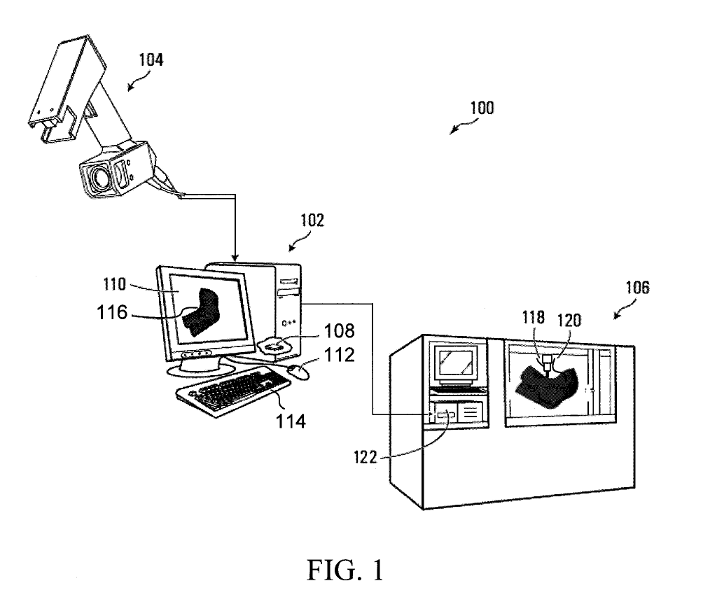

Referring to FIG. 1, a CAD/CAM (computer aided design/computer aided manufacturing) system for producing a computer representation of a three-dimensional surface of an appliance for a living body is shown generally at 100. The system 100 includes a CAD apparatus 102, a scanner 104, and a computer aided manufacturing (CAM) machine 106.

The apparatus 102 is in communication with the scanner 104 for receiving a signal encoded with an input plurality of coordinates representing a general shape of a part of a living body for which the appliance is to be produced. The scanned body part may be any body part, or group of body parts in any particular orientation for which it is desired to produce an appliance. For example, the scanned body part may be posterior portion of a human patient's torso and legs and the scanned input coordinates may be used to produce a supporting seat appliance for supporting the patient's body in a seated position.

Examples of suitable scanners include the FastSCAN Cobra handheld scanner manufactured by Polhemus of Colchester, Vt., the Yeti Foot Scanner manufactured by Vorum Research Corporation of British Columbia, Canada, and the STARscanner™ manufactured by Orthomerica Products Inc. of California.

The apparatus 102 includes a processor circuit 108 for receiving the input plurality of coordinates and for producing the computer representation of the three-dimensional surface of the intended appliance. The input plurality of coordinates may be produced from coordinate points received from the scanner 104, for example. The apparatus 102 also includes a display 110 in communication with the processor circuit 108. In this embodiment the apparatus 102 also includes a pointing device 112 having one or more actuator buttons for receiving operator input from an operator of the apparatus and a keyboard 114 for receiving alphanumeric input from the operator. The processor circuit 108 produces signals for causing the display 110 to display representations of a surface of the appliance being produced and to provide interactive visual feedback during modification of the appliance by an operator in response to inputs received at the pointing device 112 and keyboard 114 for producing a final appliance. In this case, a representation of a support appliance 116 for receiving a posterior portion of a patient's body is displayed on the display 110.

In alternative embodiments the input plurality of coordinates may be provided from a library of standard shapes of previously scanned appliances which are may be scaled and otherwise modified to provide a final appliance that fits a particular patient.

In general, producing an appliance for a patient involves receiving the input plurality of coordinates defining a preliminary representation of the surface of the appliance and transforming the input plurality of coordinates into a computer representation that facilitates modifications to the shape of the appliance. Accordingly, the final appliance representation may include alterations to the shape of surfaces, such as compressions in areas of the body that tolerate pressure and/or relief in certain areas of the body that are sensitive to pressure, thus providing a comfortably fitting appliance as defined by the final appliance representation.

The CAM machine 106 generally includes a machine tool portion 118 for machining the appliance. In this case the machined appliance is a mold 120 which is subsequently used to produce a final appliance by molding a thermoplastic or other material over the mold. The machined mold 120 has a shape defined by the computer representation of the mold and generally corresponds to the shape of the scanned body part, with alterations for fit, comfort, and/or support.

The CAM machine 106 also includes a controller 122 for controlling the machine tool portion 118 of the CAM machine. The controller 122 is in communication with the apparatus 102 for receiving a signal encoded with instructions operable to control the CAM machine 106 to produce the machined appliance 120. Alternatively the instructions may be output to a computer readable medium or memory for manual transfer to the CAM machine 106. An example of suitable CAM machines are the CANFIT-PLUS™ Carver and the CANFIT™ 6-Axis Carver, both produced by Vorum Research Corporation of British Columbia, Canada.

Processor Circuit

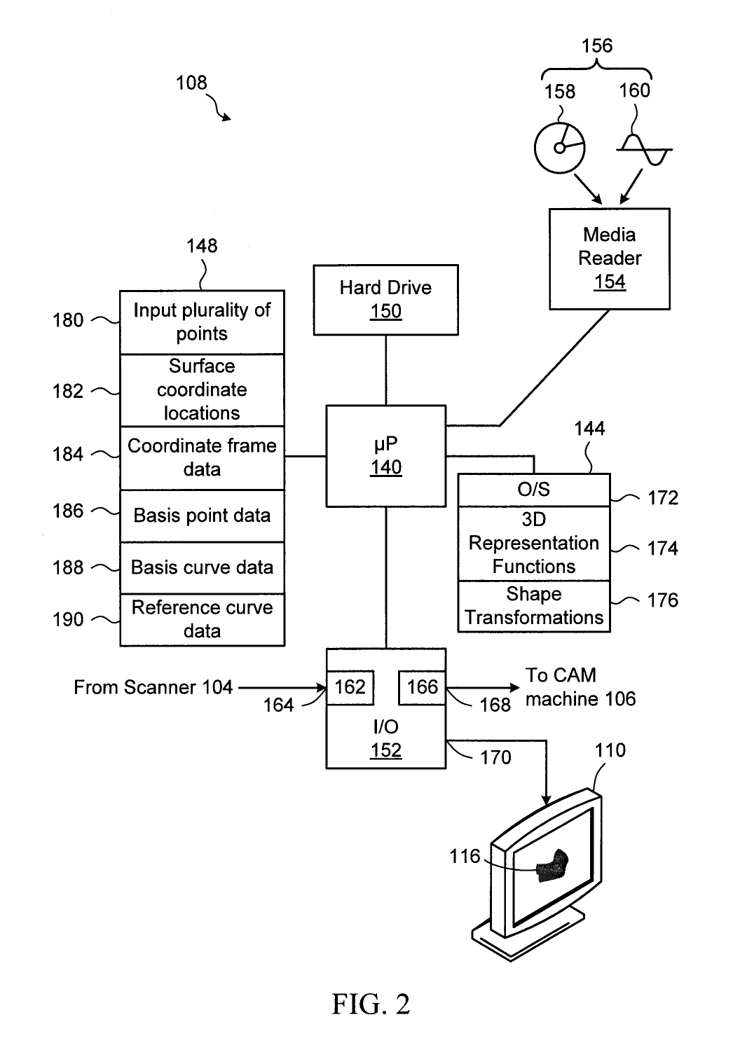

The processor circuit 108 of the apparatus 102 is shown in greater detail in FIG. 2. Referring to FIG. 2, the processor circuit 108 includes a microprocessor 140, a program memory 144, a random access memory (RAM) 148, a hard drive 150, an input output port (I/O) 152, and a media reader 154, all of which are in communication with the microprocessor 140.

Program codes for directing the microprocessor 140 to carry out various functions are stored in the program memory 144, which may be implemented as a random access memory (RAM), and/or a hard disk drive (HDD), or a combination thereof. The program memory 144 includes a block of codes 172 for directing the microprocessor to provide general operating system (O/S) functions, and a block of codes 174 for directing the microprocessor 140 to provide functions for producing the computer representation of the three-dimensional surface of the appliance. In this embodiment, the program memory 144 also includes a block of codes 176 for directing the microprocessor 140 to provide shape representation functions for modifying the computer representation of the appliance to produce the final appliance.

The media reader 154 facilitates loading program codes into the program memory 144 from a computer readable medium 156, such as a CD ROM disk 158, a flash memory (not shown), or a computer readable signal 160 such as may be received over a network such as the internet, for example. The media reader also facilitates receiving the input plurality of coordinates and/or outputting carving instructions to the computer readable medium 156 for manual transfer to the CAM machine 106.

The RAM 148 includes a plurality of storage locations including a store 180 for storing the input plurality of coordinates, a store 182 for storing surface coordinate locations, a store 184 for storing a coordinate frame data, a store 186 for storing basis point data, a store 188 for storing basis curve data, and a store 190 for storing reference curve data.

The hard drive 150 includes a plurality of storage locations for persistent storage of data, such as library shapes and operating system files, for example.

The I/O 152 includes a first interface 162 having an input 164 for receiving the signal encoded with the input plurality of coordinates from the scanner 104, and a second interface 166 having an output 168 for producing the signal encoded with the instructions for controlling the CAM machine 106 to produce the appliance. The interfaces 162 and 166 may be universal serial bus (USB) or an RS232 serial interface for example. The I/O 152 also includes an output 170 for producing a display signal for causing a representation of the appliance 116 to be displayed on the display 110.

Operation

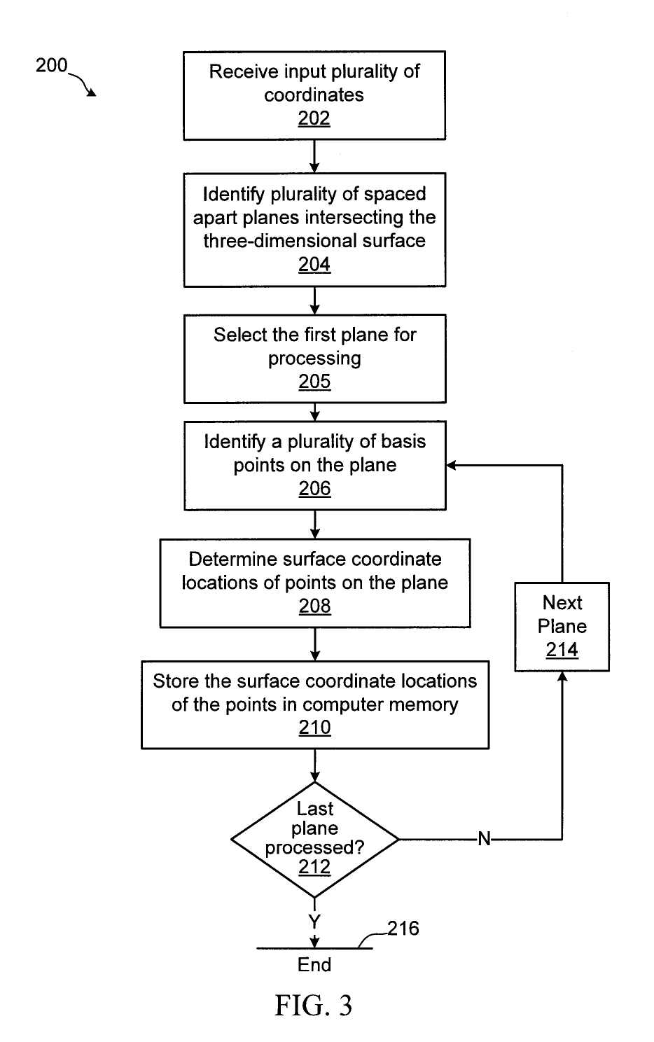

The operation apparatus 102 shown in FIG. 1 and FIG. 2 to produce the computer representation of the three-dimensional surface of the appliance is described with reference to FIGS. 3 to 7.

Referring to FIG. 3, a flowchart depicting blocks of code for directing the microprocessor 140 (shown in FIG. 2) to execute a process for producing the computer representation is shown generally at 200. The process begins at block 202, which directs the microprocessor 140 to receive an input plurality of coordinates defining a preliminary representation of the three-dimensional surface.

In one embodiment the input plurality of coordinates may be provided by scanning the patient's body using the scanner 104 shown in FIG. 1. In other embodiments the input plurality of coordinates may be read from a library of appliance shapes stored on the hard drive 150. Block 202 also directs the microprocessor 140 to store the input plurality of coordinates in the store 180 of the RAM 148 (shown in FIG. 2).

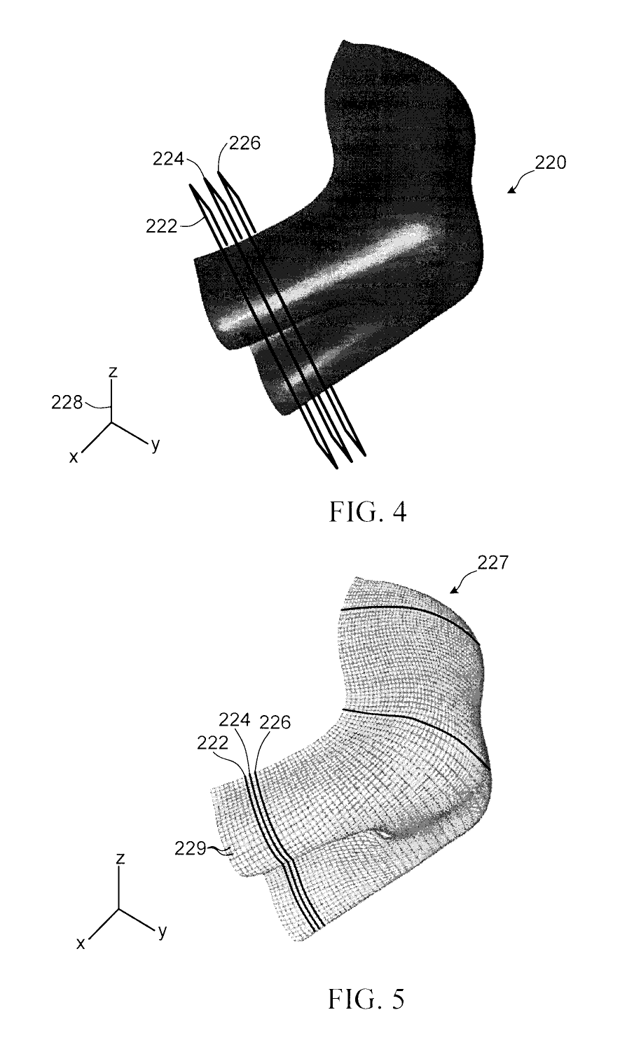

Referring to FIG. 4, a preliminary representation of a shaded three-dimensional surface of a support appliance is shown generally at 220. In this embodiment the input plurality of coordinates are defined using coordinates in a Cartesian coordinate system as indicated by coordinate axes x, y, and z shown at 228.

Referring back to FIG. 3, block 204 then directs the microprocessor 140 to identify a plurality of spaced apart planes intersecting the preliminary shape representation 220. Referring again to FIG. 4, three exemplary planes are shown including a first plane 222, a second plane 224, and a third plane 226. In practice a sufficiently large plurality of spaced apart planes would be identified to represent the preliminary shape in sufficient detail. In general, identifying the plurality of spaced apart planes 222-226 involves defining coordinates of the planes in a coordinate space such as the Cartesian coordinate system 228, such as for example defining plane coordinate frames defined within the Cartesian coordinate space 228, as described later herein.

In some embodiments, the input plurality of coordinates may be received in a format that already has defined planes (such as the planes 222-226). For example, referring to FIG. 5, the shape representation 220 may be received as a surface polygon mesh 227, having vertices lying in spaced apart planes defining a plurality of rectangles 229. In this case, the planes 222, 224, and 226 (shown bolded) may be used as provided by the surface mesh. However, more commonly the preliminary shape representation will require processing to produce the planar mesh shape shown in FIG. 5, as described later herein. For example, a common file format output by many scanners (such as the scanner 104) is StL (“StereoLithography”) file format, which uses triangular polygons to represent three-dimensional surfaces. Accordingly, the triangular polygons would have to be re-sampled to produce the planar mesh shown in FIG. 5.

Referring back to FIG. 3, the process 200 then continues at block 205, which directs the microprocessor 140 to select the first identified plane for processing.

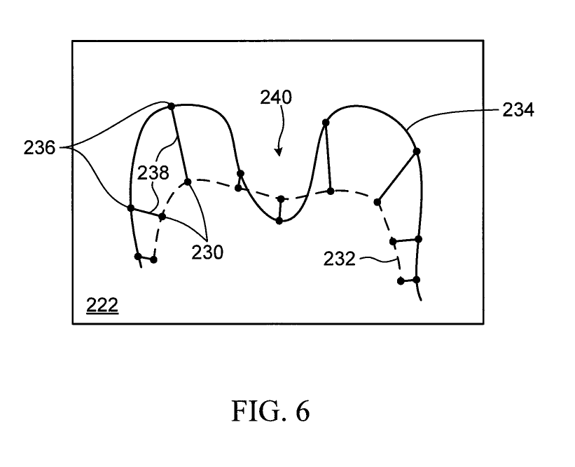

Block 206 then directs the microprocessor 140 to identify a plurality of basis points on the first plane 222. Referring to FIG. 6, the plane 222 is shown in orthogonal (plan) view, and includes a plurality of basis points 230 lying generally along a curve 232. A polyline 234 is shown linking points of intersection between the shape representation 220 and the plane 222. The polyline 234 is made up of a plurality of line segments and the curve 232 generally has a shape that at least generally follows some portions of the polyline 234. In the embodiment shown, the curve 232 is not closed since the outline of the shape being represented is a shell shape. However, in other embodiments the curve 232 may have closed ends for representing a closed shape, such as a prosthesis, for example.

Referring back to FIG. 3, block 208 then directs the microprocessor 140 to determine surface coordinate locations of a plurality of points on the plane that lie on the preliminary shape representation 220. Referring again to FIG. 6, a plurality of points 236 lying on the polyline outline 234 have surface coordinate locations defined by respective offsets 238 from the respective basis points 230. In the embodiment shown, the offsets 238 are taken in a direction normal to the curve 232. Determining locations of the points 236 on the plane 222 may involve interpolating between vertices of the surface representation lying in proximity to the plane 222, for example.

Referring back to FIG. 3, the process then continues at block 210 which directs the microprocessor 140 to store the surface coordinate locations in the store 182 of the RAM 148.

The process then continues at block 212, which directs the microprocessor 140 to determine whether the last plane has been processed. If there are still planes left in the plurality of planes that have not yet been processed then the process continues at block 214, which directs the microprocessor 140 to select the next plane for processing. Block 214 also directs the microprocessor 140 back to block 206 and blocks 206-212 are repeated for each successive plane (such as the planes 224 and 226 shown in FIG. 4).

If at block 212, there are no more planes remain that are still to be processed, then the process 200 ends at 216.

Advantageously, by representing surface coordinate locations of points on the shape representation 220 (shown in FIG. 4) using offsets from a plurality of basis points provides for and accurate shape representation. Referring back to FIG. 6, prior art shape representations may have difficulty in accurately representing regions such as the region shown generally at 240, and in such cases surface coordinates may end up being sparsely represented in these regions. Advantageously, using the basis points 230 along the curve 232 facilitates identification of a sufficiently dense number of surface coordinate locations in the region 240 to permit accurate representation of even complex shapes.

Furthermore, representation of surface coordinate locations using spaced apart planes facilitates simple modification of the appliance, for example by scaling along a plane to change the size of the appliance, or by changing the spacing and/or relative orientation between planes to alter the shape of the appliance. Such shape modifications may be advantageously performed by an operator who is not necessarily expert in three-dimensional CAD, as the spaced apart planes facilitate intuitive shape transformations without requiring in-depth knowledge of three-dimensional geometric transformations.

Identifying Planes

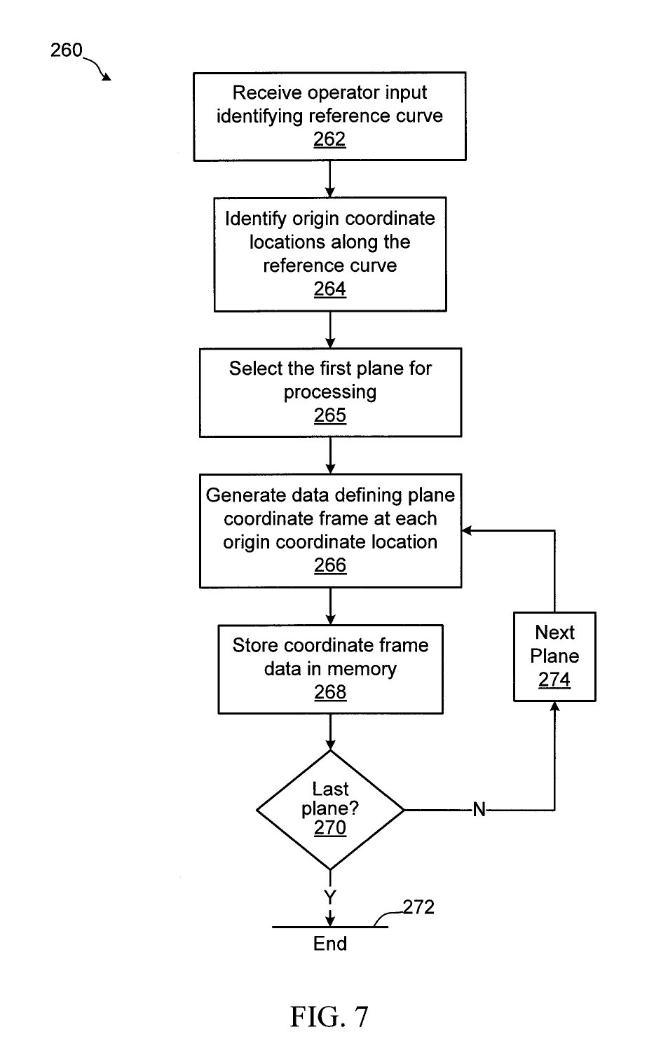

One operational embodiment of block 204 of the process 200 is shown in greater detail in FIG. 7. Referring to FIG. 7, a flowchart depicting blocks of code for directing the microprocessor 140 to execute a process for identifying the plurality of spaced apart planes is shown generally at 260.

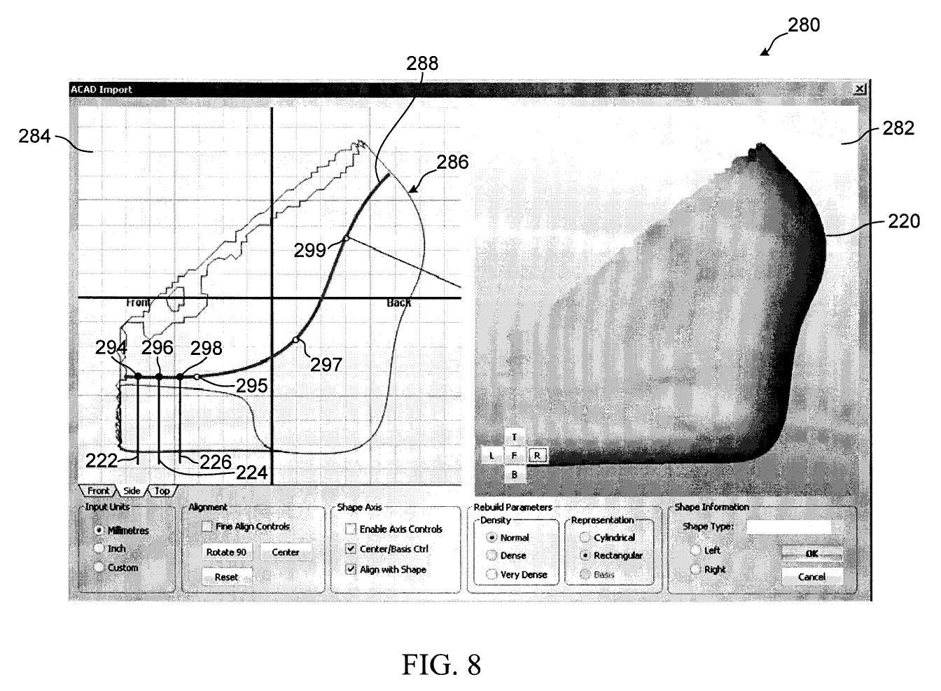

The process 260 begins at block 262, which directs the microprocessor 140 to display a screen for receiving operator input identifying a reference curve. Referring to FIG. 8, a screenshot showing a side view of the shape representation 220 is shown generally at 280. The screenshot 280 represents an operator interface for receiving input from an operator for identifying the plurality of spaced apart planes 222-226 as shown in FIG. 4. The screenshot 280 includes a window 282 for viewing a shaded version of the preliminary shape representation 220, and a window 284 for viewing an outline shape 286 of the shaded shape representation 220 shown in the window 282. In general, shading the three-dimensional shape representation involves shading underlying polygons making up the shape using a shading algorithm such as Gouraud shading.

The window 284 also displays a reference curve 288. The reference curve 288 may be identified in response to operator input received at the pointing device 112 and/or keyboard 114 (shown in FIG. 1) to identify control points (not shown) of a reference curve, such as a B-spline curve. The control points may then be interactively positioned and adjusted by the operator to achieve a desired shape of the reference curve 288. The operator may also move control points to cause the reference curve 288 to be shaped to generally correspond to one or more features of the three-dimensional surface that it is desired to accurately represent. For example, the reference curve 288 may generally follow an anatomical axis of the body part or parts that the appliance is to support.

Referring back to FIG. 7, block 626 also directs the microprocessor 140 to store data defining the reference curve (such as control point and/or endpoint coordinate locations) in the reference curve data store 190 of the RAM 148 shown in FIG. 2.

The process 260 then continues at block 265, which directs the microprocessor 140 to select the first plane for processing. Block 264 then directs the microprocessor 140 to identify origin coordinate locations along the reference curve 288. In the embodiment shown, the reference curve 288 is subdivided to produce a plurality of regularly spaced apart origin coordinate locations, such as the three coordinate locations 294, 296, and 298 shown. While only three origin coordinate locations are shown, it should be understood that further origin coordinate locations will generally be identified along the reference curve 288. In this embodiment the reference curve is subdivided to produce regularly spaced apart origin coordinate locations 294, 296, and 298 having sufficient density to permit accurate representation of the three-dimensional surface.

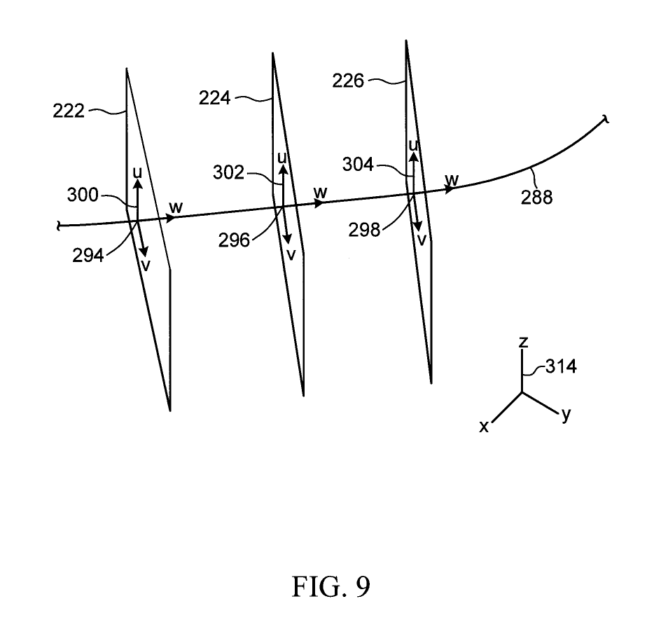

The process 260 then continues at block 266, which directs the microprocessor 140 to generate data defining a plane coordinate frame at each origin location. In general, the plane coordinate frames are defined in a three-dimensional coordinate system (for example the Cartesian coordinate system shown in FIG. 4) and generally define locations of the spaced apart plurality of planes 222-226. Referring to FIG. 9, a portion of the reference curve 288 is shown in greater detail. Each of the origin coordinate locations 294, 296, and 298, are shown having a respective coordinate frame 300, 302, and 304. The coordinate frames 300, 302, and 304 are each oriented orthogonally with respect to the reference curve 288 at the origin coordinate locations 294, 296, and 298. The w-axis of each coordinate frame 300, 302, and 304 is oriented along the reference curve and the uv-axes define the respective planes 222, 224, and 226.

The coordinate frames 300, 302, and 304 are in turn defined in the (x,y,z) three-dimensional coordinate system shown at 314. In the embodiment shown the coordinate frames 300, 302, and 304 are defined as Cartesian coordinate frames, but in other embodiments alternative coordinate systems may be used to define the coordinate frames. Advantageously, all points lying on the u-v axes (i.e. the planes 222-226) are two-dimensional coordinates and have a w coordinate value of zero.

In one embodiment, the coordinate frames 300, 302, and 304 are defined by a three-dimensional modeling matrix:

$$M = [ \begin{matrix}{a}_{11} & {a}_{12} & {a}_{13} & 0 \\ {a}_{21} & {a}_{22} & {a}_{23} & 0 \\ {a}_{31} & {a}_{32} & {a}_{33} & 0 \\ {a}_{41} & {a}_{42} & {a}_{43} & 1\end{matrix} ] , \qquad Eqn 1$$

where the elements a₁₁, a₁₂, and a₁₃ represent a unit vector defining the u-axis of the coordinate frame, a21, a₂₂, and a₂₃ represent a unit vector defining the v-axis of the coordinate frame, and a₃₁, a₃₂, and a₃₃ represent a unit vector defining the w-axis of the coordinate frame. The elements a₄₁, a₄₂, and a₄₃ represent x, y, and z values of the origin coordinate location for in the (x,y,z) coordinate system 314 of each of the respective coordinate frames 300, 302, and 304. The modeling matrix M may be used to transform two-dimensional surface coordinates lying on the u-v plane into three-dimensional coordinates defined in the three-dimensional coordinate system 314. Each two-dimensional u-v plane coordinate may be represented by the vector

P̅=[u v 0 1] Eqn 2

where the w coordinate is zero everywhere on the planes 222-226. Similarly, three-dimensional coordinates may be represented by the vector:

Q̅=[x y z 1] Eqn 3

Transforming two-dimensional plane coordinates into three-dimensional (x,y,z) coordinates thus involves, the following matrix multiplication:

Q̅= P̅M. Eqn 4

Conversely, transforming three-dimensional (x,y,z) surface coordinates into two-dimensional plane coordinates involves the following matrix multiplication:

P̅= Q̅M⁻¹ Eqn 5

Advantageously, the above coordinate transformations permit the appliance to be conveniently modified in the two-dimensional uv-axis planes or by relocating the coordinate frames 300, 302, and 304 with respect to each other and then transformed into three-dimensional (x,y,z) coordinates for producing the final appliance using the CAM machine 106 shown in FIG. 1.

Referring back to FIG. 7, the process 260 then continues at block 268, which directs the microprocessor 140 to store the data defining the plane coordinate frame (i.e. elements of the modeling matrix M) in the store 184 of the RAM 148 (shown in FIG. 2). Block 270 then directs the microprocessor 140 to determine whether the last coordinate frame for the last of the plurality of origin coordinate locations along the reference curve 288 has been identified, in which case the process ends at 272.

If at block 270, the last coordinate frame for the last of the plurality of origin coordinate locations along the reference curve 288 has not yet been identified, then the microprocessor 140 is directed to block 274. Block 274 directs the microprocessor 140 to select the next plane for processing and directs the microprocessor 140 to return to block 266 and repeat blocks 266-270.

Defining Basis Points

Referring back to FIG. 8, in one embodiment identifying the basis points (i.e. block 206 shown in FIG. 3) generally involves defining one or more basis curves along the reference curve 288 and projecting the basis curve onto the planes 222- 226. In the embodiment shown, three basis curve plane locations 295, 297, and 299 are shown.

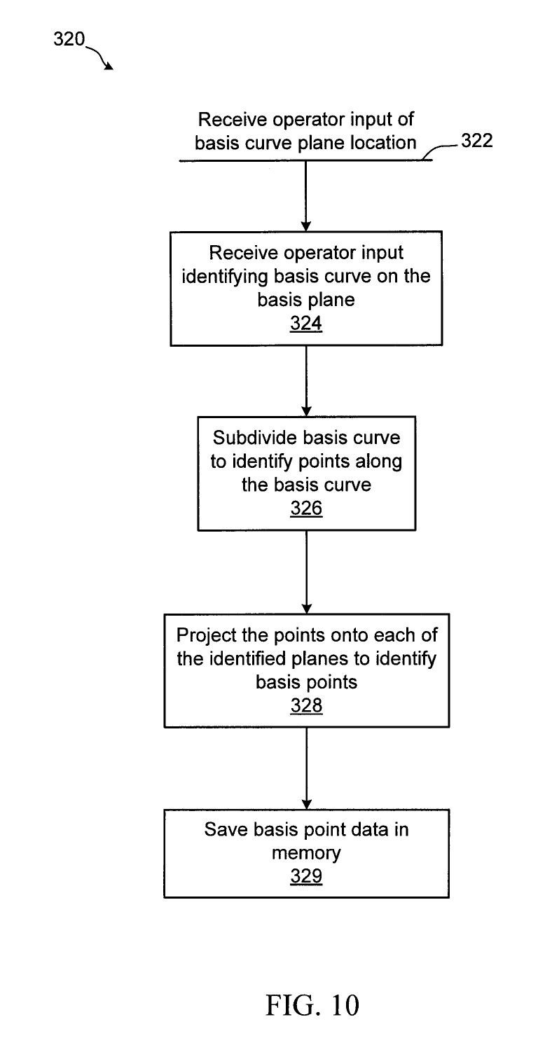

Referring to FIG. 10, a flowchart depicting blocks of code for directing the processor circuit 140 to execute a process for indentifying the basis points in the planes 222-226 is shown generally at 320. In one embodiment, the process 320 may be executed after defining the reference curve 288, as described above and before identifying the plurality of spaced apart planes.

The process begins at block 322, when operator input is received indicating a new basis curve plane location along the reference curve 288. Referring back to FIG. 8, in the embodiment shown, three basis curve plane locations 295, 297, and 299 are identified. The basis curve planes are not necessarily co-planar with any of the spaced apart plurality of planes (for example the planes 222-226) and may be located anywhere along the reference curve 288. However, in this embodiment the basis curve planes are also defined by a coordinate frame (not shown) in the same way as described above in connection with the spaced apart planes 222-226.

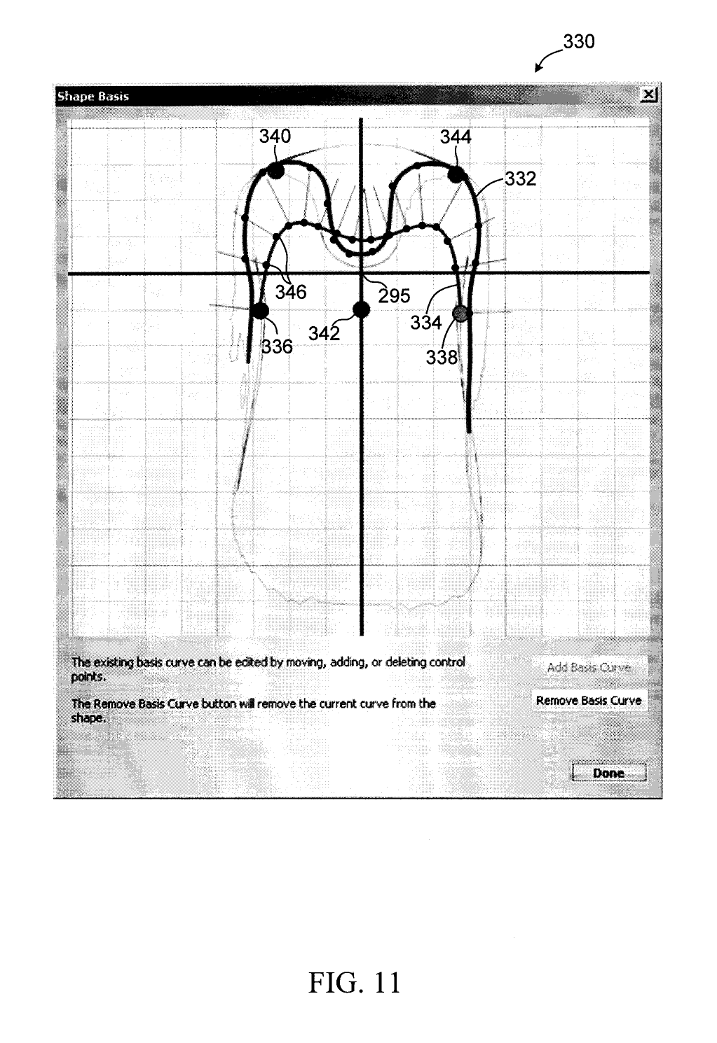

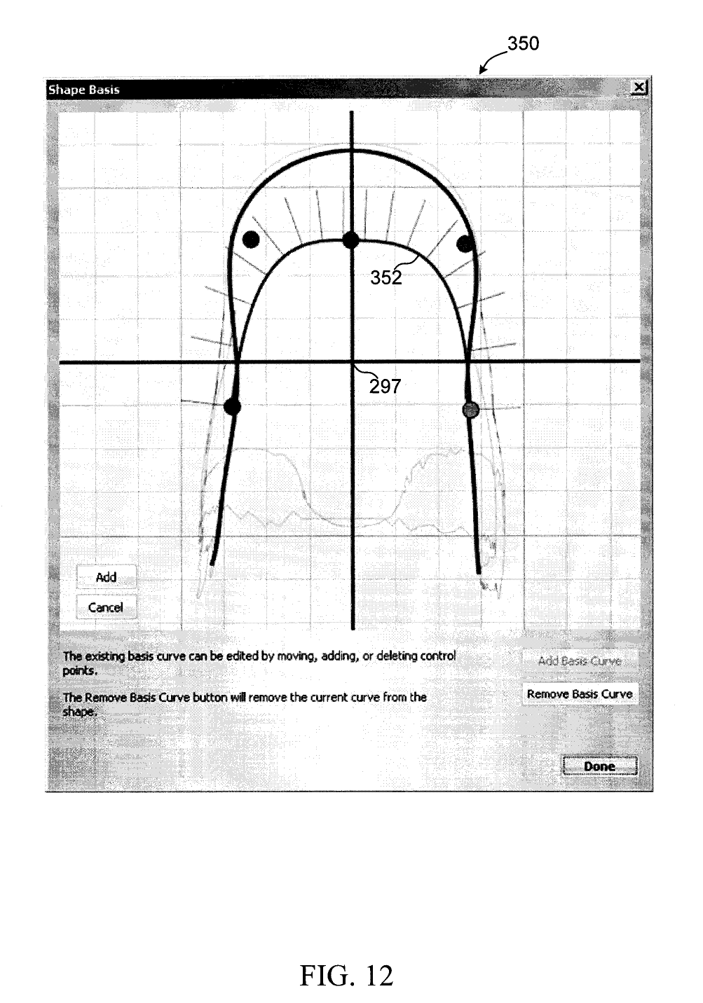

Referring to FIG. 11, a screenshot of a user interface window displayed in response to the operator clicking on the basis curve plane location 295 is shown generally at 330. The window 330 generally provides an orthographic view of a basis curve plane at the location 295. The window 330 includes a displayed polyline outline 332, which indicates points of intersection between the polygons of the three-dimensional preliminary shape and the basis curve plane.

The process 320 then continues at block 324, which directs the microprocessor 140 to receive operator input identifying a basis curve 334 on the basis curve plane displayed in the window 330. In this embodiment, the basis curve 334 comprises a B-spline curve having endpoints 336 and 338, and having a shape defined by control points 340, 342, and 344. When the window 330 is first displayed for the operator, the basis curve 334 may be defined as an initial quadratic or cubic B-spline curve located in a default position with respect to the basis curve plane origin coordinate location 295. The operator may then drag the endpoints 336 and 338 and control points 340, 342, and 344 to define a desired shape and location of the basis curve. The operator may also click on the displayed screen to add further control points to the B-spline curve. In general B-spline curves may be represented by two or more control points (i.e. endpoints 336 and 338 and zero or more additional control points). B-spline curves with three control points are usually quadratic Bezier curves, and with four control points are usually cubic Bezier curves. Higher order shapes having more than four control points are generally represented as smoothly connected Bezier curves of lower order.

Referring back to FIG. 10, block 324 also directs the microprocessor 140 to store coordinates of the locations of the endpoints 336 and 338 and control points 340, 342, and 344 in the basis curve store 188 of the RAM 148 (shown in FIG. 2). As in the case of the spaced apart planes 222-226, the saved coordinate locations may be defined as two-dimensional coordinates referenced to a basis curve plane coordinate frame.

The process then continues at block 326, which directs the microprocessor 140 to subdivide the basis curve 334 to identify a plurality of points 346 (shown in FIG. 11) along the basis curve. The number of points 346 is generally selected to provide a sufficiently dense representation of the three-dimensional surface, and in one embodiment the number of points identified may be about 60 points.

Block 328 then directs the microprocessor 140 to project the points identified at block 326 onto the spaced apart planes 222-226 to determine locations of the basis points on each plane (i.e. the basis points 230 shown in FIG. 6). In embodiments where only one basis curve plane location 295 is identified, the basis points in each of the spaced apart planes 222-226 will lie along a curve having the same shape and location as the basis curve shown at 334 in FIG. 11.

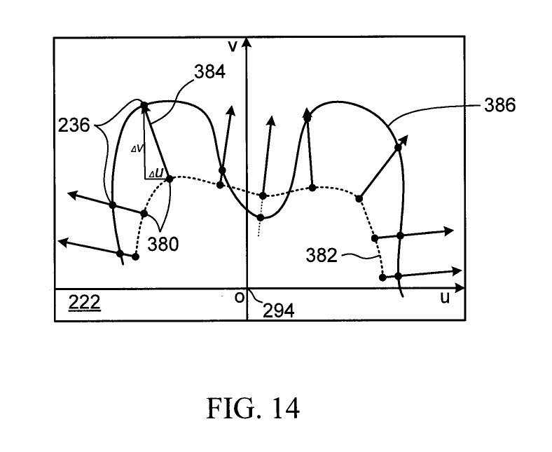

Referring to FIG. 14, the plane 222 is again shown in orthogonal (plan) view, including a plurality of basis points 380 along a curve 382. Each basis point 380 has a ray 384 located at the basis point. In this embodiment the ray 384 is normal to the curve 382 at the respective basis point. The basis point 380 may thus be represented as a unit vector or ray having elements defined as follows:

R̅=[u v Δu Δv] Eqn 6

where u and v are the coordinates of the basis point 230 in the uv-axes and Δu and Δv provide a slope or gradient defining the direction of the ray.

Referring back to FIG. 10, the process 320 then continues at block 329, which directs the microprocessor 140 to store element values of the ray R for each of the identified basis points 380 in the store 186 of the RAM 148 (shown in FIG. 2).

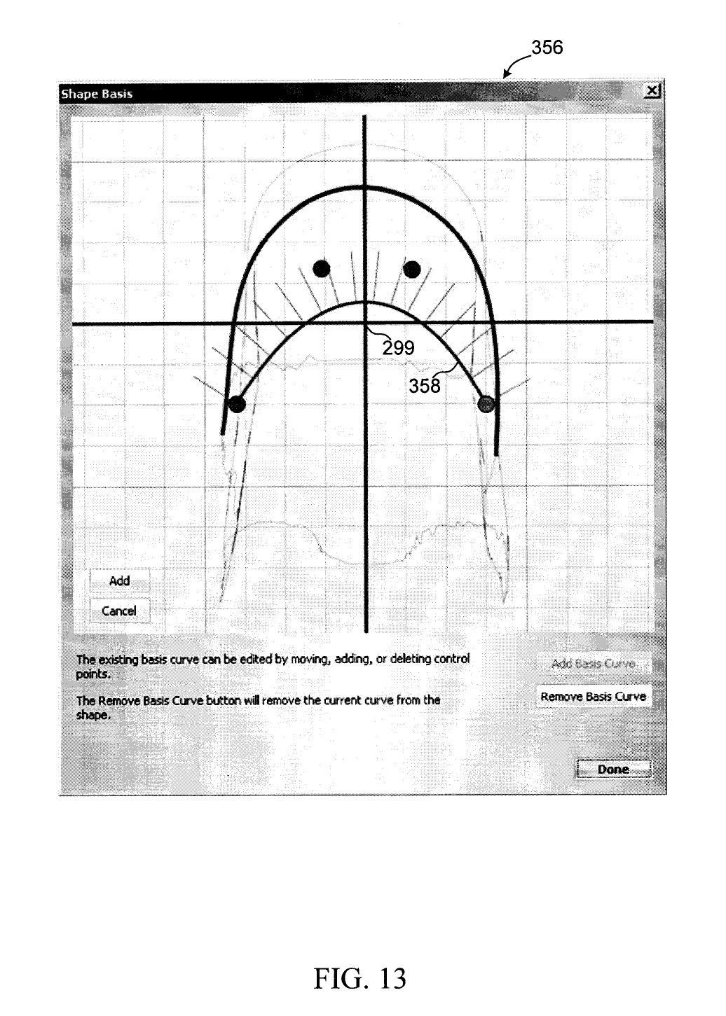

In the embodiment shown in FIG. 8, three basis curve plane locations 295, 297, and 299 are shown. The process 320 may then be executed for each of the remaining basis curve plane locations 297 and 299 as described above for the basis curve plane location 295. Referring to FIG. 13 and FIG. 14, screenshots of respective user interface windows for receiving user input defining respective basis curves 352 and 358 are shown at 350 and 356 respectively.

Referring back to FIG. 10, each time a new basis curve is added (for example at the basis curve plane location 297), block 328 directs the microprocessor 140 to project the points onto the spaced apart planes 222-226. As described above, when only a single basis curve plane location is defined, point locations are duplicated across the plurality of spaced apart planes to produce corresponding basis points on each of the planes. When two or more basis curve plane locations are identified, locations of basis points on the spaced apart planes are interpolated between corresponding points on each of the two defined basis curves for planes in-between the defined basis curves and extrapolated for other planes not located in-between. In this embodiment the interpolation/extrapolation is performed using a cubic function or other non-linear interpolation methods. In general the set of basis curves, when projected onto the spaced apart planes may be viewed as together defining a basis surface, which forms a template shape for producing the representation of the three-dimensional surface.

In other embodiments, basis curve plane locations 295, 297, and 299 may be constrained to lie on one of the spaced apart plurality of planes such as the planes 222-226 shown in FIG. 8.

Determining Surface Coordinate Locations

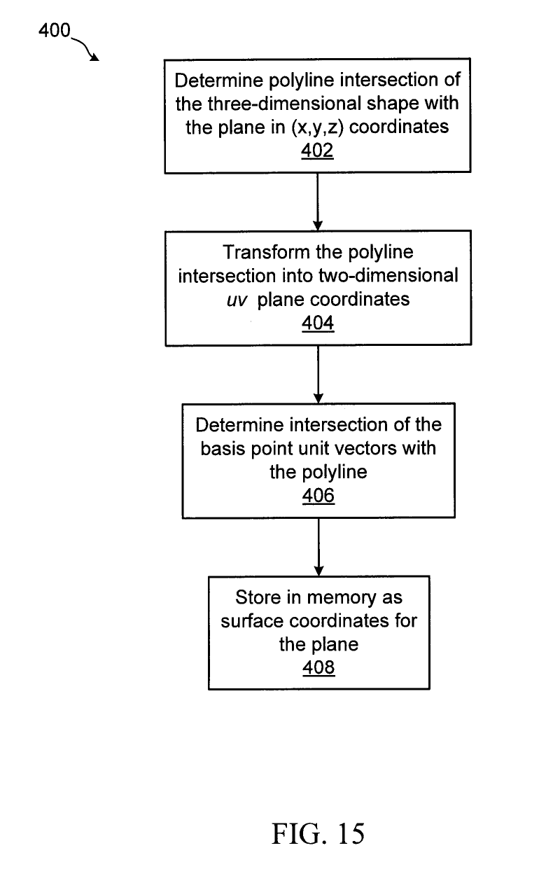

One embodiment of the block 208 of the process 200 shown in FIG. 3 for determining surface coordinate locations is shown in greater detail at 400 in FIG. 15.

The process 400 begins at block 402, which directs the microprocessor 140 to determine the intersection of the preliminary three-dimensional shape with the plane (i.e. one of the spaced apart planes such as the plane 222). As stated above, the preliminary three-dimensional surface of the appliance is generally represented using a collection of flat polygons, a subset of which will each intersect the plane 222 at two edges of the polygon thus defining pairs of points making up line segments. Coordinates of the points the three-dimensional (x,y,z) coordinate system may then be interpolated from the coordinate locations of the vertices of the flat polygons to yield a set of (x,y,z) points defining a polyline of intersection between the three-dimensional shape and the plane 222.

Block 404 then directs the microprocessor 140 to transform the polyline coordinates from three-dimensional (x,y,z) coordinates into two-dimensional coordinates on the plane 222 using equation 5 above. The transformation results in a plurality of points 380 having coordinates defined in the plane 222.

The process 400 then continues at block 406, which directs the microprocessor 140 to determine points of intersection of the basis point rays 384 (read from the store 186 of the RAM 148 in FIG. 2) on the plane 222. Referring back to FIG. 14, a general shape of the polyline of the intersection with the plane is shown at 386. By determining intersections between the rays 384 and the polyline 386, a plurality of surface coordinate locations 388 may be determined on the plane. The intersection coordinate locations will not necessarily lie at the two-dimensional polyline points transformed in block 404, and interpolation will be required between points on the polyline to determine the surface coordinate locations along the polyline.

Block 408 then directs the microprocessor 140 to store the surface coordinate locations 388 in the store 182 of the RAM 148. Since the surface coordinate locations are determined with reference to the basis points 380, in one embodiment surface coordinate locations may be stored as an offset distance and a reference to the corresponding basis point 380. Accordingly, to identify each surface coordinate locations on the plane would require only a reference to the basis point and an offset therefrom to be stored in the store 182. Basis point coordinate locations are stored in the store 186 and may be conveniently referenced to avoid duplication.

Advantageously, by using basis curves and/or basis points to provide a template for representing a three-dimensional shape of the appliance facilitates representation of complex shapes by permitting the basis curve shape to be selected as a template. The template shape may be selected to permit accurate representation of all portions of the appliance.

While specific embodiments of the invention have been described and illustrated, such embodiments should be considered illustrative of the invention only and not as limiting the invention as construed in accordance with the accompanying claims.

1. A method for producing a computer representation of a three-dimensional surface of an appliance for a living body, the method comprising:
identifying a plurality of spaced apart planes intersecting the three-dimensional surface;
for each plane in said plurality of spaced apart planes:
identifying a plurality of basis points on said plane, said basis points lying generally along a curve on said plane;
determining surface coordinate locations of a plurality of points on said plane that lie on said three-dimensional surface, each surface coordinate location being defined as an offset from said basis point; and
storing said surface coordinate locations in a computer memory.

2. (canceled)

3. The method of claim 1 further comprising transforming said surface coordinate locations into a set of instructions operable to control a computer aided manufacturing machine to produce the appliance.

4. The method of claim 1 further comprising applying a shape transformation to said surface coordinate locations to produce modified surface coordinate locations and wherein storing said surface coordinate locations in said computer memory comprises storing said modified surface coordinate locations in said computer memory.

5. The method of claim 1 wherein identifying said plurality of spaced apart planes comprises identifying a plurality of plane coordinate frames respectively identifying locations and orientations of said plurality spaced apart planes in a three-dimensional coordinate system.

6. The method of claim 5 wherein identifying said plurality of plane coordinate frames comprises:
identifying origin coordinate locations of a plurality of spaced apart points along a reference curve, said reference curve having a shape that generally corresponds to a shape of the three-dimensional surface in a first general direction along the surface; and
for each respective origin coordinate location, generating data defining a plane coordinate frame having an origin located at said origin coordinate location and being oriented to cause a corresponding plane defined by said plane coordinate frame to be orthogonally oriented with respect to a portion of said reference curve passing through said origin coordinate location.

7. The method of claim 6 further comprising:
displaying a representation of said three-dimensional surface; and
receiving operator input identifying control point locations defining said reference curve.

8. (canceled)

9. (canceled)

10. The method of claim 5 wherein identifying said plurality of plane coordinate frames comprises, for each of said plurality of plane coordinate frames, generating a modeling matrix having:
elements defining orthogonal unit vectors, said orthogonal unit vectors identifying an orientation of said plane coordinate frame; and
elements defining an origin coordinate location of said plane coordinate frame.

11. The method of claim 10 wherein determining said surface coordinate locations comprises:
determining two-dimensional surface coordinate locations with respect to said plane coordinate frame; and
transforming said two-dimensional surface coordinates into three-dimensional coordinates in said three-dimensional coordinate system using said modeling matrix.

12. The method of claim 1 further comprising:
defining at least one basis curve located on a basis curve plane intersecting the three-dimensional surface;
subdividing said at least one basis curve to identify a plurality of points along said basis curve; and
wherein identifying said plurality of basis points on each of said planes comprises projecting respective points in said plurality of points along said basis curve onto each of said planes.

13. The method of claim 12 wherein projecting said respective points comprises at least one of:
interpolating between points located on at least two basis curves located on respective basis curve planes; and
extrapolating from at least one point located on said at least one basis curve.

14. The method of claim 12 wherein defining said at least one basis curve located on said basis curve plane comprises defining at least one basis curve located on one of said spaced apart plurality of planes.

15. The method of claim 12 wherein defining said basis curve comprises defining a B spline curve located in said plane.

16. (canceled)

17. (canceled)

18. (canceled)

19. (canceled)

20. The method of claim 1 further comprising determining two-dimensional coordinate locations on said plane of a polyline linking points of intersection between said three-dimensional surface and said plane and wherein determining said offset from each said basis point comprises determining a distance between said basis point and a point of intersection between said polyline and a ray extending from said basis point in a direction normal to said curve.

21. The method of claim 20 wherein determining said two-dimensional coordinate locations on said plane of said polyline comprises determining three-dimensional coordinates of said points of intersection and transforming said points of intersection into two-dimensional coordinates on said plane.

22. An apparatus for producing a computer representation of a three-dimensional surface of an appliance for a living body, the apparatus comprising:
means for identifying a plurality of spaced apart planes intersecting the three-dimensional surface;
means for identifying a plurality of basis points for each plane in said plurality of spaced apart planes, said basis points lying generally along a curve on said plane;
means for determining surface coordinate locations of a plurality of points on each said plane that lie on said three-dimensional surface, each surface coordinate location being defined as an offset from said basis point; and
means for storing said surface coordinate locations in a computer memory.

23. (canceled)

24. The apparatus of claim 22 further comprising means for transforming said surface coordinate locations into a set of instructions operable to control a computer aided manufacturing machine to produce the appliance.

25. The apparatus of claim 22 further comprising means for applying a shape transformation to said surface coordinate locations to produce modified surface coordinate locations and wherein said means for storing said surface coordinate locations in said computer memory comprises means for storing said modified surface coordinate locations in said computer memory.

26. The apparatus of claim 22 wherein said means for identifying said plurality of spaced apart planes comprises means for identifying a plurality of plane coordinate frames respectively identifying locations and orientations of said plurality spaced apart planes in a three-dimensional coordinate system.

27. The apparatus of claim 26 wherein said means for identifying said plurality of plane coordinate frames comprises:
means for identifying origin coordinate locations of a plurality of spaced apart points along a reference curve, said reference curve having a shape that generally corresponds to a shape of the three-dimensional surface in a first general direction along the surface; and
means for generating data defining respective plane coordinate frames each having an origin located at respective origin coordinate locations and being oriented to cause a corresponding plane defined by said plane coordinate frame to be orthogonally oriented with respect to a portion of said reference curve passing through said origin coordinate location.

28. The apparatus of claim 27 further comprising:
means for displaying a representation of said three-dimensional surface; and
means for receiving operator input identifying control point locations defining said reference curve.

29. (canceled)

30. (canceled)

31. The apparatus of claim 26 wherein said means for identifying said plurality of plane coordinate frames comprises means for generating a modeling matrix for each of said plurality of plane coordinate frames, each said modeling matrix having:
elements defining orthogonal unit vectors, said orthogonal unit vectors identifying an orientation of said plane coordinate frame; and
elements defining an origin coordinate location of said plane coordinate frame.

32. The apparatus of claim 31 wherein said means for determining said surface coordinate locations comprises:
means for determining two-dimensional surface coordinate locations with respect to said plane coordinate frame; and
means for transforming said two-dimensional surface coordinates into three-dimensional coordinates in said three-dimensional coordinate system using said modeling matrix.

33. The apparatus of claim 22 further comprising:
means for defining at least one basis curve located on a basis curve plane intersecting the three-dimensional surface;
means for subdividing said at least one basis curve to identify a plurality of points along said basis curve; and
wherein said means for identifying said plurality of basis points on each of said planes comprises means for projecting respective points in said plurality of points along said basis curve onto each of said planes.

34. The apparatus of claim 33 wherein said means for projecting said respective points comprises at least one of:
means for interpolating between points located on at least two basis curves located on respective basis curve planes; and
means for extrapolating from at least one point located on said at least one basis curve.

35. The apparatus of claim 33 wherein said means for defining said at least one basis curve located on said basis curve plane comprises means for defining at least one basis curve located on one of said spaced apart plurality of planes.

36. The apparatus of claim 33 wherein said means for defining said basis curve comprises means for defining a B-spline curve located in said plane.

37. (canceled)

38. (canceled)

39. (canceled)

40. (canceled)

41. The apparatus of claim 22 further comprising means for determining two-dimensional coordinate locations on said plane of a polyline linking points of intersection between said three-dimensional surface and said plane and wherein said means for determining said offset from each said basis point comprises means for determining a distance between said basis point and a point of intersection between said polyline and a ray extending from said basis point in a direction normal to said curve.

42. The apparatus of claim 41 wherein said means for determining said two-dimensional coordinate locations on said plane of said polyline comprises means for determining three-dimensional coordinates of said points of intersection and means for transforming said points of intersection into two-dimensional coordinates on said plane.

43. An apparatus for producing a computer representation of a three-dimensional surface of an appliance for a living body, the apparatus comprising a processor circuit operably configured to:
identify a plurality of spaced apart planes intersecting the three-dimensional surface;
for each plane in said plurality of spaced apart planes:
identify a plurality of basis points on said plane, said basis points lying generally along a curve on said plane;
determine surface coordinate locations of a plurality of points on said plane that lie on said three-dimensional surface, each surface coordinate location being defined as an offset from said basis point; and
store said surface coordinate locations in a computer memory.

44. (canceled)

45. The apparatus of claim 43 wherein said processor circuit is operably configured to transform said surface coordinate locations into a set of instructions operable to control a computer aided manufacturing machine to produce the appliance.

46. The apparatus of claim 43 wherein said processor circuit is operably configured to apply a shape transformation to said surface coordinate locations to produce modified surface coordinate locations and to store said surface coordinate locations in said computer memory by storing said modified surface coordinate locations in said computer memory.

47. The apparatus of claim 43 wherein said processor circuit is operably configured to identify said plurality of spaced apart planes by identifying a plurality of plane coordinate frames respectively identifying locations and orientations of said plurality spaced apart planes in a three-dimensional coordinate system.

48. The apparatus of claim 47 wherein said processor circuit is operably configured to identify said plurality of plane coordinate frames by:
identifying origin coordinate locations of a plurality of spaced apart points along a reference curve, said reference curve having a shape that generally corresponds to a shape of the three-dimensional surface in a first general direction along the surface; and
for each respective origin coordinate location, generating data defining a plane coordinate frame having an origin located at said origin coordinate location and being oriented to cause a corresponding plane defined by said plane coordinate frame to be orthogonally oriented with respect to a portion of said reference curve passing through said origin coordinate location.

49. The apparatus of claim 48 wherein said processor circuit is operably configured to:
display a representation of said three-dimensional surface; and
receive operator input identifying control point locations defining said reference curve.

50. (canceled)

51. (canceled)

52. The apparatus of claim 47 wherein said processor circuit is operably configured to identify said plurality of plane coordinate frames by generating a modeling matrix for each of said plurality of plane coordinate frames, said modeling matrix having:
elements defining orthogonal unit vectors, said orthogonal unit vectors identifying an orientation of said plane coordinate frame; and
elements defining an origin coordinate location of said plane coordinate frame.

53. The apparatus of claim 52 wherein said processor circuit is operably configured to determine said surface coordinate locations by:
determining two-dimensional surface coordinate locations with respect to said plane coordinate frame; and
transforming said two-dimensional surface coordinates into three-dimensional coordinates in said three-dimensional coordinate system using said modeling matrix.

54. The apparatus of claim 43 wherein said processor circuit is operably configured to:
define at least one basis curve located on a basis curve plane intersecting the three-dimensional surface;
subdivide said at least one basis curve to identify a plurality of points along said basis curve; and
wherein said processor circuit is operably configured to identify said plurality of basis points on each of said planes by projecting respective points in said plurality of points along said basis curve onto each of said planes.

55. The apparatus of claim 54 wherein said processor circuit is operably configured to project said respective points by at least one of:
interpolating between points located on at least two basis curves located on respective basis curve planes; and
extrapolating from at least one point located on said at least one basis curve.

56. The apparatus of claim 54 wherein said processor circuit is operably configured to define said at least one basis curve located on said basis curve plane by defining at least one basis curve located on one of said spaced apart plurality of planes.

57. The apparatus of claim 54 wherein said processor circuit is operably configured to define said basis curve by defining a B-spline curve located in said plane.

58. (canceled)

59. (canceled)

60. (canceled)

61. (canceled)

62. The apparatus of claim 43 wherein said processor circuit is operably configured to determine two-dimensional coordinate locations on said plane of a polyline linking points of intersection between said three-dimensional surface and said plane and to determine said offset from each said basis point by determining a distance between said basis point and a point of intersection between said polyline and a ray extending from said basis point in a direction normal to said curve.

63. The apparatus of claim 62 wherein said processor circuit is operably configured to determine said two-dimensional coordinate locations on said plane of said polyline by determining three-dimensional coordinates of said points of intersection and by transforming said points of intersection into two-dimensional coordinates on said plane.

64. A computer readable medium encoded with codes for directing a processor circuit to produce a computer representation of a three-dimensional surface of an appliance for a living body, the codes directing the processor circuit to:
identify a plurality of spaced apart planes intersecting the three-dimensional surface;
for each plane in said plurality of spaced apart planes:
identify a plurality of basis points on said plane, said basis points lying generally along a curve on said plane;
determine surface coordinate locations of a plurality of points on said plane that lie on said three-dimensional surface, each surface coordinate location being defined as an offset from said basis point; and
store said surface coordinate locations in a computer memory.

65. (canceled)
